(19) United States
(12) Patent Application Publication
(10) Pub. No.: US 2014/0164544 A1
(43) Pub. Date: Jun. 12, 2014

(54) ENABLING A COMPUTING DEVICE TO UTILIZE ANOTHER COMPUTING DEVICE

(71) Applicant: Eric Gagneraud, Houston, TX (US)

(72) Inventor: Eric Gagneraud, Houston, TX (US)

(21) Appl. No.: 14/234,521

(22) PCT Filed: Jul. 29, 2011
(86) PCT No.: PCT/US2011/045932

§ 371 Date: Jan. 23, 2014

(51) Int. Cl. H04L 29/08

(52) U.S. Cl. CPC H04L 67/104
USPC 709/208

(57) ABSTRACT

Example embodiments disclosed herein relate to enabling a first computing device to utilize a second computing device. In example embodiments, configuration data for the second computing device, made available to the first computing device, may be used in enabling the first computing device to utilize the second computing device.

### BACKGROUND

The types and number of features available on computing devices such as notebook computers, tablet computers, mobile phones, and smart devices continues to increase. However, many of these devices still lack various common functionalities, such as the ability to print a document. Additionally, certain devices provide more advanced computing capabilities than others, and different devices may have different software packages installed at any given time. As such, enabling the sharing of resources between such computing devices may be useful.

### BRIEF DESCRIPTION OF THE DRAWINGS

The following detailed description references the drawings, wherein:

FIG. 1 is a block diagram of an example computing system for receiving and processing a request to add a contact to a user's profile;

FIG. 2 is a block diagram of an example client computing device for receiving and processing configuration data for another computing device;

FIG. 3 is a block diagram of an example computer system for configuring a contact's computing device to utilize a user's computing device;

FIG. 4 is a block diagram of an example computer system for configuring each of a plurality of computing devices associated with a contact's profile to utilize each of a plurality of computing devices associated with a user's profile;

FIG. 5 is a block diagram of an example computer system for configuring each of a plurality of computing devices associated with a contact's profile to utilize a subset of a plurality of computing devices associated with a user's profile;

FIG. 6 is a block diagram of an example computer system for configuring a computing device associated with a user's profile to utilize each of a plurality of other computing devices associated with the user's profile;

FIG. 7 is a flowchart of an example method for receiving and processing configuration data for a computing device;

FIG. 8A is a flowchart of an example method for receiving and processing a request to access a client computing device;

FIG. 8B is a flowchart of an example method for determining whether to grant a first client computing device access to a second client computing device;

FIG. 9 is a flowchart of an example method for requesting to access a client computing device; and

FIG. 10 is a flowchart of an example method for adding a computing device to a user's resource list.

### DETAILED DESCRIPTION

As noted above, enabling computing devices to share resources with one another may be useful. For example, it may be beneficial to enable a primary computing device (e.g., a laptop computer) to utilize a resource of a secondary computing device (e.g., the print function of a printer). In many cases, however, the primary device may only utilize the secondary device after being configured to use the secondary device. The process of configuring the primary device generally includes providing the primary device with information specific to the secondary device (e.g., address information, authentication information, etc.) and/or installing software (e.g., a device driver for the secondary device) on the primary device.

The configuration process is often performed manually, which can make the process time-consuming. Additionally, manual configuration can also be problematic if, for example, the operator of the primary device does not have the appropriate information or software, does not know how to obtain the appropriate information or software, or makes errors when entering the information or installing the software. The configuration process can also be inconvenient for an operator associated with the secondary device if, for example, the operator manually provides the configuration information individually to each primary device operator that it authorizes to utilize the secondary device.

To address these issues, examples disclosed herein allow a user of a social networking service to share configuration data for the user's computing devices with the computing devices of a contact identified in the user's profile in the social networking service. In particular, in some examples, a user of a social networking service may add a contact to the user's contact list. After adding the contact, the social networking service may share with the contact's computing devices configuration data for each of the user's computing devices. Each of the contact's computing devices may then be configured to utilize the user's computing devices using the received configuration data. In some examples, configuration data shared with a contact's computing device may include information identifying a location at which a device driver for a user's computing device is stored. Using the location information, the contact's computing device may obtain and install the device driver to enable the contact's computing device to utilize the user's computing device.

In this manner, a contact's computing devices may be configured to utilize a user's computing devices without the contact having to manually obtain and enter appropriate configuration information or manually identify and obtain appropriate software (e.g., device drivers). Furthermore, by sharing configuration information with a user's social networking contacts, the user may share configuration information with a select group of contacts without having to manually obtain and provide the configuration information to each contact individually. Accordingly, both the sharing of configuration information and the configuration of computing devices to utilize other devices may be performed more conveniently and with less risk of human error.

Additionally, in some examples, a user may group their contacts and then control access to configuration data based on a contact's group membership rather than controlling access individually for each contact. For example, contacts may be grouped based on a relationship with the user (e.g., family member, friend, co-worker, etc.). In some examples, a user may choose to share configuration data for all of the user's computing devices with the contacts in one group, but choose to share configuration data for only some of the user's devices with the contact in another group. By controlling access to configuration data based on group membership, a user may control access more efficiently and simply than by specifying, individually for each contact, which computing devices the contact may access.

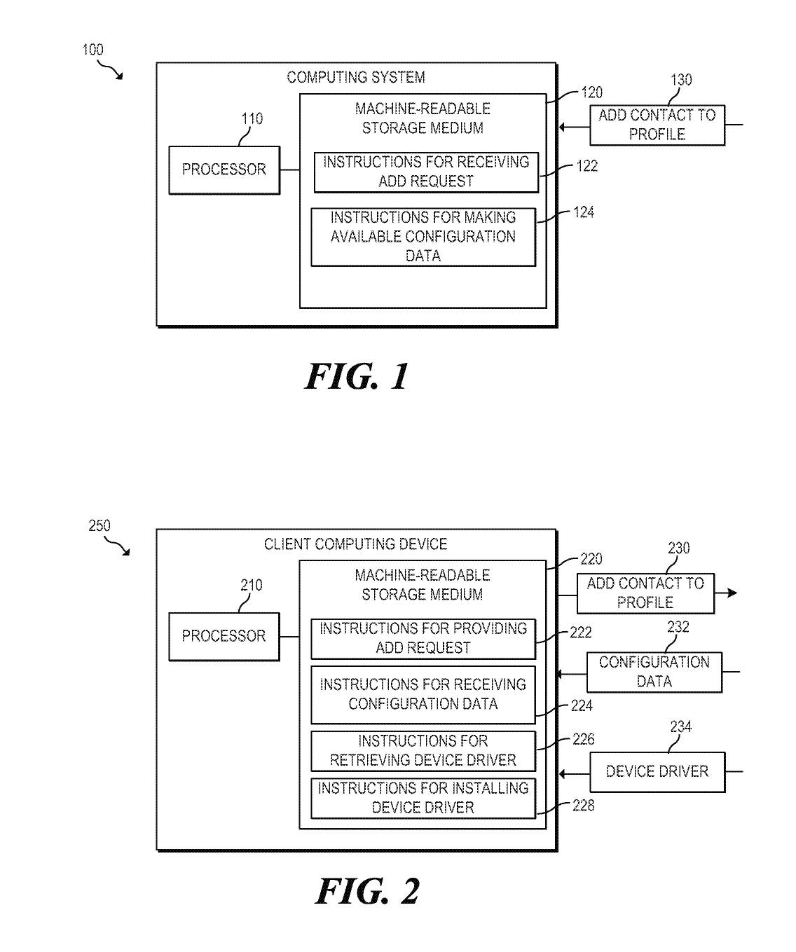

Referring now to the drawings, FIG. 1 is a block diagram of an example computing system 100 for receiving and processing a request 130 to add a contact to a user's profile. In some examples, computing system 100 may be a server computing device such as, for example, a web server, a Local Area Network (LAN) server, a file server, or any other computing device suitable for receiving and processing contact add requests. In the example of FIG. 1, computing system 100 includes a processor 110 and a machine-readable storage medium 120 including instructions 122 and 124 for receiving and processing a contact add request.

Processor 110 may be at least one central processing unit (CPU), at least one semiconductor-based microprocessor, at least one graphics processing unit (GPU), at least one other hardware device suitable for the retrieval and execution of instructions stored on a machine-readable storage medium 120, or a combination thereof. Processor 110 may include, for example, a single core on a chip, multiple cores on a chip, multiple cores across multiple chips, multiple cores across multiple devices, or a combination thereof. Processor 110 may fetch, decode, and execute instructions 122 and 124 to implement the functionality described below. As an alternative or in addition to fetching, decoding, and executing instructions, processor 110 may include at least one integrated circuit (IC), at least one other electronic circuit, other control logic, or a combination thereof for performing some or all of the functionality of instructions 122 and 124 described below.

Machine-readable storage medium 120 may be any electronic, magnetic, optical, or other physical storage device that contains or stores executable instructions. For example, machine-readable storage medium 120 may be any of Random Access Memory (RAM), flash memory, a storage drive (e.g. a hard disk), a Compact Disc Read Only Memory (CD-ROM), and the like, or a combination thereof. Further, machine-readable storage medium 120 can be non-transitory. As described below, machine-readable storage medium 120 may include instructions for receiving and processing request 130 to add a contact to a user's profile.

In the example of FIG. 1, machine-readable storage medium 120 includes instructions 122 for receiving request 130 to add a contact to a user's profile. For the sake of clarity, the terms “user” and “contact” are used herein to refer to two different members of a social networking service. The terms “user” and “contact” may refer to any two members of the social networking service, any feature described herein in relation to a “user” is equally applicable to a “contact”, and any feature described herein in relation to a “contact” is equally applicable to a “user”. Although examples are described herein in the context of a social networking service, examples described herein could also be practiced in the context of at least one server, control system, enterprise network, other suitable computing system or network, or a combination thereof.

As used herein, a “profile” is a collection of information associated with a member (e.g., individual, group, etc.) of a social networking service. Additionally, as used herein, a user's “contact list” is a portion of the user's profile including a collection of information identifying each member of a social networking service with whom the user has chosen to associate in the social networking service. A user's contact list may be populated by, for example, manually entering contact information and/or pulling contact information from other collections of contact information (e.g., e-mail contact lists, telephone contact lists, other social networking services, etc). In some examples, the social networking service may be managed by computing system 100.

Additionally, as used herein, a user's “resource list” is a portion of the user's profile including a collection of information identifying each computing resource associated with (e.g., owned, operated by, assigned to, etc.) the user. As used herein, a “computing resource” may be a computing device, a functionality of a computing device (e.g., printing, taking pictures, etc.), or a set of machine-readable instructions executable by a computing device (e.g., a software package). In some examples, in addition to information identifying each computing resource, the resource list may also include information that may be used to determine what configuration data to provide to the resource, such as a device type, a device version, a current operating system, current settings, and the like. A user's resource list may be populated by, for example, manually entering indentifying information for each computing resource associated with the user. Furthermore, as used herein, to “alter” a user's profile means to change information in the user's profile. Examples of “altering” a user's profile include adding a contact to or removing a contact from a user's contact list, adding a computing resource to or removing a computing resource from the user's resource list, changing an access control policy of the user's profile, and the like.

In response to add request 130, instructions 122 may add the contact to the user's profile. In particular, instructions 122 may, for example, add the contact to the user's contact list. In some examples, add request 130 may be provided by a client computing device operated by the user. An example of such a client computing device is described below in connection with client computing device 250 of FIG. 2. The client computing device may provide the request to computing system 100 via at least one computer network, at least one telephone network, at least one wireless communication technology, or a combination thereof. In some examples, suitable computer networks include, for example, a LAN, a wireless local area network (WLAN), a wide area network (WAN), an enterprise private network, a virtual private network (VPN), the Internet, and the like. Further, suitable telephone networks include, for example, a wired telephone network, a wireless telephone network (e.g., a cellular network), and the like. Additionally, in some examples, the client computing device may provide request 130 to computing system 100 via a website or web-based application, an application running in an operating system of the client computing device, and the like.

In response to request 130 received by instructions 122, instructions 124 may make available, to a computing device associated with the contact's profile, configuration data for a computing device associated with the user's profile. As used herein, a computing device “associated with” a member's profile (e.g., a user's profile or a contact's profile) is a computing device identified in the resource list of the member's profile. For ease of description, a computing device associated with a contacts profile may be referred to herein as a “contact's computing device” and a computing device associated with a user's profile may be referred to herein as a “user's computing device”. Additionally, as used herein, configuration data referred to as configuration data “for” a first computing device means configuration data useable by a second computing device to configure the second device to communicate with and/or utilize the first computing device.

In some examples, instructions 124 may make available the configuration data by providing the configuration data to the contact's computing device in response to request 130. If the contact's computing device is not available when attempting to provide the configuration data (e.g., the device is off), then instructions 124 may repeatedly reattempt to provide the configuration data. In alternative examples, instructions 124 may make available the configuration data by granting the contact's computing device access to the configuration data. In such examples, instructions 124 may provide the configuration data to the contact's computing device when requested for the contact's computing device. Instructions 124 may, for example, provide the configuration data to the contact's computing device in response to a request to allow the contact's computing device to utilize the user's computing device. In other examples, instructions 124 may make the configuration data available to the contact's computing device (e.g., a first computing device associated with the contact) by making the configuration data available to a second computing device associated with the contact's profile in response to request 130, such as when the first computing device does not have access to a computer network. In such examples, the configuration data may subsequently be transferred from the second computing device to the first computing device (e.g., via a Universal Serial Bus (USB) memory device, or the like).

In some examples, the configuration data is useable by the contact's computing device to obtain instructions executable by the contact's computing device that, when executed, enable the contact's computing device to utilize the user's computing device. The configuration data may include, for example, address information for a location at which the executable instructions are stored. In some examples, the instructions executable by the contact's computing device may include a device driver or a portion of a device driver. As used herein, a “device driver” means information including a set of machine-readable instructions useable by the operating system of a primary computing device to utilize and/or communicate with a secondary computing device in a format (e.g., using code) that the secondary computing device is able to interpret. In some examples, the set of machine-readable instructions may comprise at least one function that may be called by the operating system of the primary device to communicate with the secondary computing device in a format the secondary computing device is able to interpret. The device driver may be, for example, at least one library or other type of file.

A storage location at which the executable instructions are stored may be, for example, in a storage area that is remote from computing system 100, such as a remote file server. In other examples, the storage location may be in a local storage area of computing system 100, where the local storage area includes at least one data storage device, such as a hard disk, a solid state drive, tape drive, and the like, or any combination thereof.

In addition or alternatively, the configuration data may include other information that may be utilized by the contact's computing device to gain access to the user's computing device and/or to configure the contact's computing device to utilize the user's computing device. For example, the configuration data may include authentication information useable by the contact's computing device to authenticate itself to the user's computing device, or indicate where such information is stored. The authentication information may include, for example, at least one of information identifying the user's computing device (e.g., a device name or number), security parameters (e.g., login information, a password or a public key), and the like, or a combination thereof. In some examples, the configuration data may also include device settings to be used by the contact's computing device when utilizing or otherwise communicating with the user's computing device, or indicate where such information is stored.

In the examples described above, the contact's computing device may gain access to sufficient information for configuring the contact's computing device to utilize at least one of the user's computing devices without any manual transfer of configuration data between the user and the contact. Additionally, in some examples, by making configuration data available in response to an add request, the contact's computing device may be configured to utilize a user's computing device prior to or in response to a request by the contact's computing device to utilize the user's computing device. In this manner, examples described herein may simplify and streamline the process of sharing resources between computing devices, as the contact's computing device may have access to sufficient information to utilize a user's computing device when a utilization request is made. As one example, after adding a contact to a user's contact list, the contact's laptop may have access to sufficient information to configure the laptop to utilize the user's home printer. As such, when the contact visits the user's home, for example, the contact may be able to print documents from the laptop using the user's printer without first having to manually obtain and enter configuration information for the printer.

FIG. 2 is a block diagram of an example client computing device 250 for receiving and processing configuration data for another computing device. Client computing device 250 may be, for example, a chip set of a computing system, a desktop computer, a notebook computer, a slate or tablet computer, a mobile phone, a smart device (e.g., a smartphone), a peripheral device (e.g., a printer, data storage drive, camera, router, etc.), or any other computing device suitable for communicating with computing system 100. In the example of FIG. 2, client computing device 250 includes a processor 210 and a machine-readable storage medium 220. Client computing device 250 is described below with reference to an example in which client computing device 250 is a contacts computing device. However, in other examples, client computing device 250 may be a user's computing device.

Processor 210 may be implemented in any manner described above in relation to processor 110 of FIG. 1. Processor 210 may fetch, decode, and execute instructions 222, 224, 226, and 228 to implement the functionality described below. As an alternative or in addition to fetching, decoding, and executing instructions, processor 210 may include at least one IC, at least one other electronic circuit, other control logic, or a combination thereof, that comprise a plurality of electronic components for performing some or all of the functionality of instructions 222, 224, 226, and 228 described below.

Machine-readable storage medium 220 may be implemented in any manner described above in relation to machine-readable storage medium 120 of FIG. 1. Machine-readable storage medium 220 may include instructions 222 for providing an add request 230 to a server, such as computing system 100 of FIG. 1 in examples in which computing system 100 is a server computing device as described above in relation to FIG. 1. In examples in which client computing device 250 is a contact's computing device, instructions 222 may provide to the server a request 230 to add the contact to a user's profile. In particular, request 230 may be a request to add the contact to the user's contact list. In some examples, the server may request the user's permission to add the contact to the user's contact list prior to adding the contact. Alternatively, the server may add the contact to the user's profile in response to request 230.

After the contact has been added to the user's profile (e.g., by adding the contact to the user's contact list), the server may make available to client computing device 250 configuration data 232 for a user's computing device. Configuration data 232 may be similar to the configuration data described above in relation to FIG. 1. In some examples, the user's computing device may be similar to client computing device 250. The server may make available the configuration data in any manner described above in relation to computing system 100 of FIG. 1. Instructions 224 may then receive from the server configuration data 232, which is similar to the configuration data described above in relation to FIG. 1.

In some examples, a device driver 234 may be stored in a location specified by configuration data 232. In such examples, after the receipt of configuration data 232, instructions 226 may retrieve device driver 234 from the storage location using the address information included in configuration data 232. The storage location may be, for example, on a web server. In such examples, the address information may be a Uniform Resource Locator (URL), and the instructions 226 may use the URL to retrieve device driver 234 from the web server via the Internet. In other examples, the address information may specify a storage location on a computer network, such as a LAN, WAN, VPN, etc., to which both the server and client computing device 250 have access. In such examples, the address information may include the address (e.g., the Internet Protocol (IP) address) of the storage device and the address of the storage location on the storage device.

After instructions 226 have retrieved device driver 234, instructions 228 may install device driver 234 on client computing device 250. Device driver 234 may be useable by client computing device 250 to utilize and/or communicate with a user's computing device. In some examples, instructions 228 may install device driver 234 without requiring any input from the contact. In addition to address information, configuration data 232 may include other configuration information, as described above in relation to computing system 100 of FIG. 1. In such examples, instructions 228 may use this additional configuration information to install device driver 234 without any input from the contact or any other user. Additionally or alternatively, instructions 228 may use the additional configuration information to further configure client computing device 250 to utilize the user's computing device. In other examples, instructions 228 may request input from the contact when installing device driver 234 on client computing device 250.

Further, in some examples, configuration data 232 may be used to enable client computing device 250 to communicate with and/or utilize the user's computing device directly, independent of the server or any client program for communication with the server on either client computing device 250 or the user's computing device. For example, client computing device 250 may be enabled to utilize and/or communicate with the user's computing device without installing any program on or otherwise modifying the user's computing device. In some examples, device driver 234 may enable such utilization and/or communication.

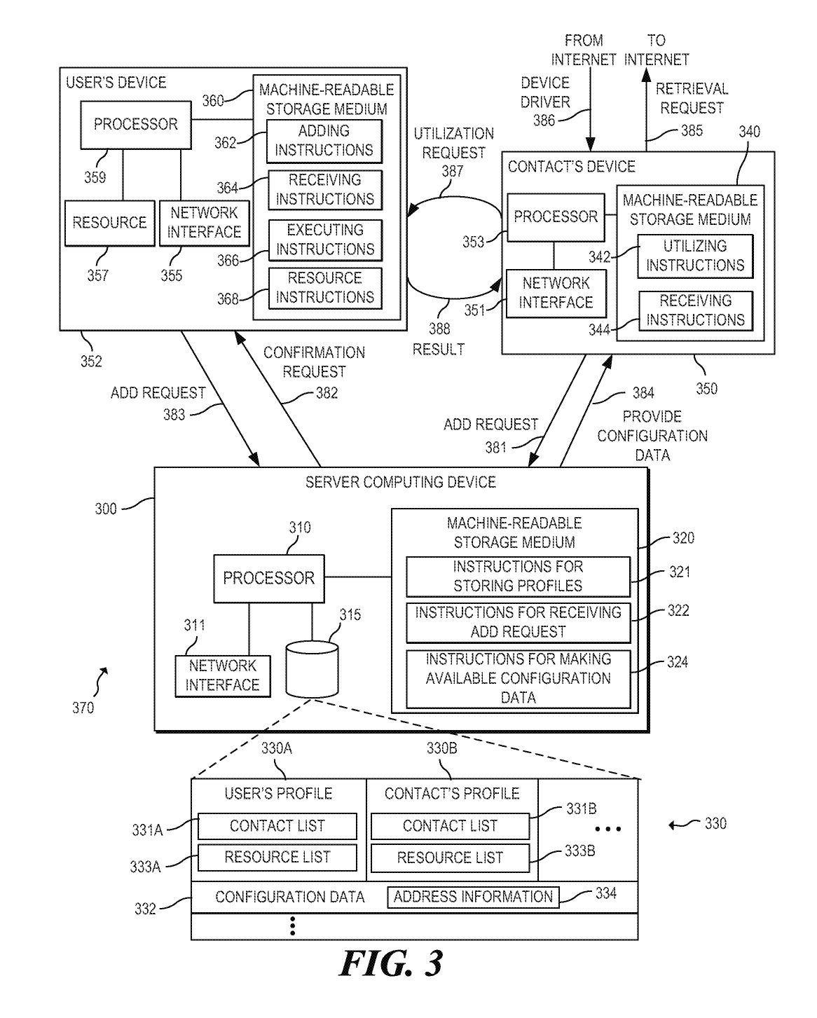

FIG. 3 is a block diagram of an example computer system 370 for configuring a contact's computing device 350 to utilize a user's computing device 352. In the example of FIG. 3, computer system 370 includes a server computing device 300 in addition to contact's computing device 350 and a user's computing device 352.

Server computing device 300 is similar to computing system 100 of FIG. 1, and includes a processor 310, a machine-readable storage medium 320, a network interface 311, and a storage area 315. In the example of FIG. 3, machine-readable storage medium 320 is similar to machine-readable storage medium 120 of FIG. 1. Machine-readable storage medium 320 includes instructions 322 and 324, which are similar to instructions 122 and 124, respectively, and includes additional instructions 321. Processor 310 is similar to processor 110, except that processor 310 may fetch, decode, and execute and/or include a plurality of electronic components for performing some or all of the functionality of instructions 321, 322, and 324.

Network interface 311 may include, for example, at least one hardware component that may be used by server computing device 300 to communicate over at least one computer network, at least one telephone network, at least one wireless communication technology, or a combination thereof, as described above. In some examples, server computing device 300 may communicate with client computing devices (e.g., contact's computing device 350 and user's computing device 352) over the Internet or other another computer network using network interface 311. Storage area 315 may comprise a number of physical media for storing data, such as at least one hard disk, solid state drive, tape drive, and the like, or any combination thereof. In some examples, storage area 315 may include a plurality of storage devices that, in combination, form a pool of available storage.

Machine-readable storage medium 320 includes instructions 321 for storing profiles 330. In some examples, server computing device 300 may manage a social networking service, or a portion thereof. In such examples, server computing device 300 may store profiles 330 for members of the social networking service. In the example of FIG. 3, instructions 321 store a plurality of profiles 330, each including a contact list and resource list, in storage area 315. In other examples, instructions 321 may store profiles 330 partially or completely in at least one storage area remote from server computing device 300. As shown in FIG. 3, profiles 330 may include, for example, a user's profile 330A and a contact's profile 330B. The user's profile 330A includes the user's contact list 331A and resource list 333A, and the contact's profile 330B includes the contact's contact list 331B and resource list 333B. In the example of FIG. 3, user's resource list 333A includes the user's computing device 352 (i.e., includes information identifying device 352) and the contact's resource list 333B includes the contact's computing device 350.

Instructions 321 may also store, in storage area 315, configuration data 332 for each computing resource identified in each resource list 333A, 333B, etc. Configuration data 332 is similar to the configuration data described above in relation to FIG. 1 and may include address information 334. In other examples, instructions 321 may store some or all of configuration data 332 in a storage area remote from server computing device 300. Additionally, for each computing resource, configuration data 332 may, for example, include data for configuring a plurality of different devices to utilize the computing resource. In such examples, server 300 may make available to a particular device the portions of configuration data 332 useable to configure that device to utilize the computing resource. Furthermore, in some examples, instructions 321 may store profiles 330 and configuration data 332 as a database. The database may be stored in storage area 315, a remote storage area, or a combination thereof. In some examples, each member may provide server computing device 300 with configuration data 332 for each of the computing resources identified in the resource list of their profile. For example, a member may provide device drivers or address information 334 for device drivers for each computing resource in the member's resource list. In such examples, server computing device 300 may store the information provided by the members. In other examples, server computing device may use information provided by the members (e.g., address information 334) to obtain device drivers for the member's computing resources. In still other examples, server computing device 300 may obtain configuration data 332 (e.g., from the internet) based on identifying information provided by members for the computing resources identified in their resource lists.

Instructions 322 may receive an add request 381 from contact's computing device 350. Add request 381 may correspond to add request 230 described above in relation to FIG. 2. In some examples, instructions 322 may add the contact (i.e., add information indentifying the contact) to the user's profile 330A in response to add request 381. In such examples, add request 381 may correspond to add request 130 described above in relation to FIG. 1. In particular, instructions 322 may add the contact to the user's contact list 331A in response to add request 381. In other examples, instructions 322 may first request confirmation from the user before adding the contact. In such examples, instructions 322 provide a confirmation request 382 to users computing device 352 in response to add request 381. Instructions 322 may receive a denial or an add request 383 in response to confirmation request 382. Instructions 322 may add the contact to the users contact list 331A (i.e., to the users profile 330A) after receiving add request 383. In such examples, add request 383 may correspond to add request 130 of FIG. 1. Alternatively, the request to add the contact may originate with the user. In such examples, instructions 322 may receive add request 383, and add the contact to the users contact list 333A in response, without first receiving add request 381 or providing confirmation request 382.

After the contact is added to the user's contact list 331A (i.e., to the user's profile 330A), instructions 324 make available, to at least one computing resource identified in the contact's resource list 333B, configuration data for at least one computing resource identified in the users resource list 333A. In the example of FIG. 3, instructions 324 make available to contact's computing device 350 configuration data 332 for user's computing device 352. Instructions 324 may make available configuration data 332 in any manner described above in relation to computing system 100 of FIG. 1. In the example of FIG. 3, instructions 324 provide configuration data 332 to the client's computing device 350 via a communication 384.

In the example of FIG. 3, contact's computing device 350 is an example of client computing device 250 described above in relation to FIG. 2. Contact's computing device 350 includes a machine-readable storage medium 340, a network interface 351, and a processor 353. Machine-readable storage medium 340 is similar to machine-readable storage medium 220, except that machine-readable storage medium 340 includes instructions 342 and 344 in addition to instructions 222, 224, 226, and 228. Additionally, network interface 351 may be similar to network interface 311 of server computing device 300. Processor 353 may be similar to processor 210 of client computing device 250, except that processor 353 is additionally configured to communicate with and utilize network interface 351, and may additionally fetch, decode, and execute and/or include a plurality of electronic components for performing some or all of the functionality of instructions 342 and 344.

The functionality of instructions 222, 224, 226, and 228 of contact's computing device 350 described above is similar to the functionality of those instructions as described above in relation to FIG. 2. In the example of FIG. 3, instructions 222 may provide add request 381 to server computing device 300. Then, instructions 224 may receive configuration data 332 from server computing device 300 via communication 384. In response, instructions 226 may provide a retrieval request 385 to a remote storage area via the Internet, and then receive a device driver 234 via communication 386. After device driver 234 is received, instructions 228 may install device driver 234 to configure contact's computing device 350 to utilize user's computing device 352. Instructions 342 may then provide a utilization request 387 to user's computing device 352. Instructions 344 may receive a result 388 returned by user's computing device 352 in response to utilization request 387.

In the example of FIG. 3, user's computing device 352 is similar to client computing device 250 described above in relation to FIG. 2. In particular, user's computing device 352 may be any type of computing device described above in relation to client computing device 250. User's computing device 352 includes a machine-readable storage medium 360, a network interface 355, a resource 357, and a processor 359. Machine-readable storage medium 360 may be implemented in any manner described above in relation to machine-readable storage medium 120 of FIG. 1, and includes instructions 362, 364, 366, and 368. In some examples, machine-readable storage medium 360 may also include instructions 222, 224, 226, and 228 of FIG. 2. Network interface 355 is similar to network interface 311 of server computing device 300. Resource 357 may be a hardware component capable of providing, individually or in combination with resource instructions 368, at least one function that may be utilized by contact's computing device 350, as described below. Processor 359 is similar to processor 210 of client computing device 250, except that processor 359 is additionally configured to communicate with and utilize network interface 351 and resource 357, and may additionally fetch, decode, and execute and/or include a plurality of electronic components for performing some or all of the functionality of instructions 362, 364, 366, and 368 in addition or as an alternative to instructions 222, 224, 226, and 228.

In the example of FIG. 3, adding instructions 362 may provide add request 383 to server computing device 300. Adding instructions 362 may also receive confirmation request 382 prior to providing add request 383. Receiving instructions 364 may receive utilization request 387 provided by contact's computing device 350, and executing instructions 366 may execute the utilization request 387. In some examples, executing instructions 366 may be capable of invoking any function that may be performed by user's computing device 352. Additionally, device driver 234 may enable contact's computing device 350 to provide utilization request 387 in a format that user's computing device 352 is able to interpret.

Utilization request 387 may request the performance of some function of resource 357 and/or resource instructions 368. For example, user's computing device 352 may be a printer, and resource 357 may be hardware components configured to reproduce text and graphics on physical print media. In such examples, utilization request 387 may include a request to print a document, and executing instructions 366 may cause the hardware components of resource 357 to print the document. In other examples, user's computing device 352 may be a hard disk drive, resource 357 may be a hard disk, utilization request 387 may request that a file be stored on the hard disk, and executing instructions 366 may store the file on the hard disk. Alternatively, utilization request 387 may request the performance of a function of resource instructions 368 (e.g., a function of software installed on user's computing device 352). In such examples, executing instructions 366 may cause resource instructions 368 to execute the requested function. After executing the requested function, resource instructions 368 may provide a result 388 (e.g., the result of a computation performed by resource instructions 368) to contact's computing device 350. As described above, user's computing device 352 may be any of a number of different computing devices, and the functions that may be invoked by executing instructions 366 may depend on the type of device 352 and/or the contents of resource instructions 368 (e.g., the software installed on device 352).

In alternative examples, contacts computing device 350 may request from server computing device 300 permission to utilize user's computing device 352 prior to providing utilization request 387. Additionally, in some examples, contact's computing device 350 may have no network interface 351. In such examples, contact's computing device 350 may be connected (e.g., via a USB port) to another computing device having a network interface and communicate with user's computing device 352 and server computing device 300 through that computing device. User's computing device 352 may similarly use another computing device to communicate if user's computing device 352 has no network interface.

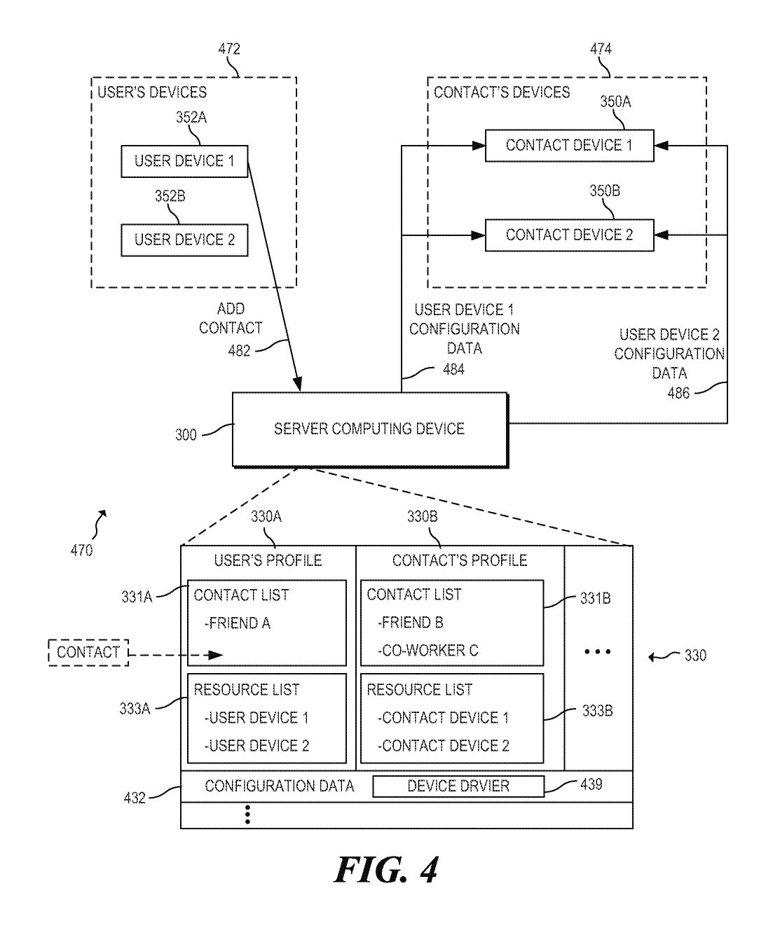

FIG. 4 is a block diagram of an example computer system 470 for configuring each of a plurality of contact's computing devices 350A, 350B to utilize each of a plurality of user's computing devices 352A, 352B. In the example of FIG. 4, computing system 470 includes a user's resources 472 including the user's first and second computing devices 352A and 352B, and a contact's resources 474 including the contact's first and second computing devices 350A and 350B. In some examples, each of user's computing devices 352A and 352B may be similar to user's computing device 352 described above in relation to FIG. 3, and each of user's computing devices 350A and 350B may be similar to user's computing device 350 described above in relation to FIG. 3.

Computing system 470 includes a server computing device 300 comprising a machine-readable storage medium 320 including instructions 321, 322, and 324, as described above in relation to FIG. 3. Server computing device 300 of FIG. 4 may store profiles 330, each including a contact list and a resource list, as described above in relation to FIG. 3. As shown in FIG. 4, contact list 331A of users profile 330A initially includes “Friend A”, and resource list 333A of users profile 330A includes the user's first and second computing devices 352A and 352B of the user's resources 472. Additionally, contact list 331B of contact's profile 330B includes “Friend B” and “Co-Worker C,” and resource list 333B of contact's profile 330B includes the contact's first and second computing devices 350A and 350B of the contact's resources 474.

In the example of FIG. 4, instructions 322 of server computing device 300 may receive a request 482 to add the contact to the user's contact list 331A (i.e., to the user's profile 330A). Request 482 may be provided by user's computing device 352A. Alternatively, request 482 may be provided by any other computing device operated by the user. In response to request 482, instructions 322 may add the contact to user's contact list 331A.

Also in response to request 482, instructions 324 may make available to each of the computing devices in the contact's resource list 333B configuration data 332 for each of the computing devices in the user's resource list 333A. For example, instructions 324 may make available to contact's computing devices 350A and 350B of the contact's resource list 333B configuration data 332 for each of user's computing devices 352A and 352B of the user's resource list 333A. Instructions 324 may make available configuration data 332 in any manner described above in relation to computing system 100 of FIG. 1.

In the example of FIG. 4, instructions 324 provide configuration data 432 for the user's first computing device 352A to the contact's first and second devices 350A and 350B via a communication 484. Additionally, instructions 324 provide configuration data 432 for the user's second computing device 352B to the contact's first and second devices 350A and 350B via a communication 486. After receiving the configuration data from server computing device 300, each of the contact's first and second computing devices 350A and 350B may use the configuration data to configure themselves to utilize each of the user's first and second computing devices 352A and 352B, as described above in relation to client computing device 250 of FIG. 2.

In some examples, configuration data 432 may be similar to the configuration data described above in relation to FIG. 1. In other examples, as shown in FIG. 4, configuration data 432 includes at least one device driver 439 for a computing device in addition or as an alternative to address information 334 described above. In such examples, configuration data 432 may include a separate device driver 439 for each of a plurality of different computing devices. Additionally, configuration data 432 may be stored with profiles 330 (e.g., in a database in storage area 315 or a remote storage area). In the example of FIG. 4, the computing devices in groups 472 or 474 may be any type of client computing device described above in relation to client computing device 250. Further, each of groups 472 and 474 may include a plurality of different types of computing devices.

In the example of FIG. 4 described above, by adding the contact to the user's contact list, each of the contact's computing devices in the contact's resource list may gain access to configuration data for each of the user's computing devices in the user's resource list. In addition or alternatively, each of the user's computing devices in the user's resource list may also gain access to configuration data for each of the contact's computing devices in the contact's resource list in response to the same add request. In this manner, these examples may further simplify and streamline the process of sharing resources between computing devices, as multiple computing devices of a contact, for example, may have access to sufficient information to utilize multiple computing devices associated with a user's profile after the contact is added to the user's contact list.

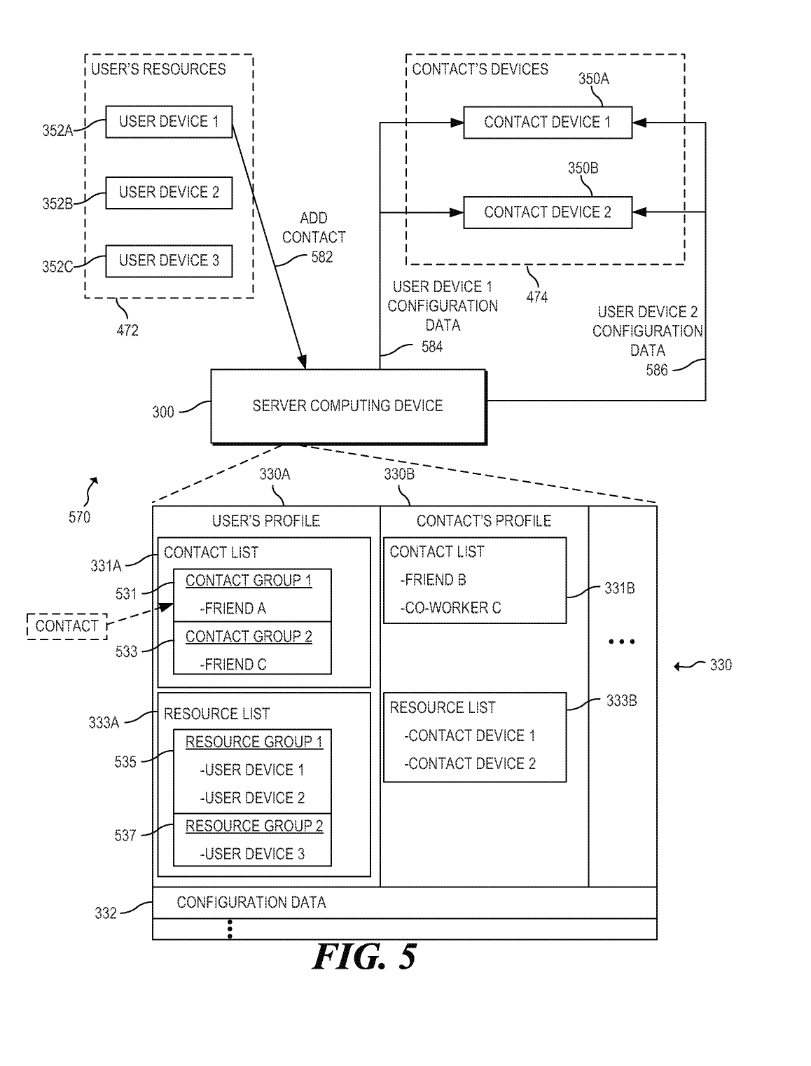

FIG. 5 is a block diagram of an example computer system 570 for configuring each of a plurality of contact's computing devices 350A, 350B to utilize a subset of a user's computing devices. In the example of FIG. 5, computing system 570 includes the user's resources 472 including the user's first, second, and third computing devices 352A, 352B, and 352C, and a contact's resources 474 including the contact's first and second computing devices 350A and 350B. Computing system 570 also includes a server computing device 300 comprising a machine-readable storage medium 320 including instructions 321, 322, and 324, as described above in relation to FIG. 3. In some examples, each of user's computing devices 352A, 352B, and 352C may be similar to user's computing device 352 described above in relation to FIG. 3, and each of user's computing devices 350A and 350B may be similar to user's computing device 350 described above in relation to FIG. 3.

Server computing device 300 of FIG. 5 may store profiles 330, each including a contact list and a resource list, as described above in relation to FIG. 3. In some examples, a contact list may include a plurality of contact groups and a resource list may include a plurality or resource groups. In the example of FIG. 5, the user's contact list 331A includes first and second contact groups 531 and 533, each including different members of a social networking service. In addition, the user's resource list 333A includes first and second resource groups 535 and 537, each including different resources. In some examples, the user may specify (e.g., in the user's profile 330A) different access control policies for the members in different contact groups, rather than granting all members in the user's contact list 331A access to the configuration data for all of the resources in the user's resource list 333A.

Instructions 322 of server computing device 300 may receive a request 582 to add the contact to the user's first contact group 531 of user's profile 330A. In the example of FIG. 5, request 582 is provided by user's computing device 352A. In other examples, request 582 may be provided by any other computing device operated by the user. In response to request 582, instructions 322 may add the contact to user's first contact group 531.

In the example of FIG. 5, all of the entities of the user's first contact group 531 are granted access to all of the resources of the user's first resource group 535 and none of the resources in the user's second resource group 537. Accordingly, in response to request 582, instructions 324 may make available to each of the computing devices in the contact's resource list 333B configuration data 332 for each of the computing devices in the user's first resource group 535. However, instructions 324 do not make available to the computing resources in the contact's resource list 333B configuration data 332 for any computing device in the user's second resource group 537. In some examples, server computing device may prevent the computing devices in the user's first resource group 535 from accessing the configuration data for any computing device in the user's second resource group 537. Configuration data 332 may be the same as the configuration data described above in relation to FIG. 3 and/or FIG. 4.

In the example of FIG. 5, instructions 324 may make available to contact's computing devices 350A and 350B of the contact's resource list 333B configuration data 332 for each of user's computing devices 352A and 352B of the user's first resource group 535. Instructions 324 may make available the configuration data 332 in any manner described above in relation to computing system 100 of FIG. 1. In the example of FIG. 5, instructions 324 provide configuration data 332 for the user's first computing device 352A to the contact's first and second computing devices 350A and 350B via a communication 584. Additionally, instructions 324 provide configuration data 332 for the user's second computing device 352B to the contact's first and second devices 350A and 350B via a communication 586. After receiving the configuration data from server computing device 300, each of the contact's first and second computing devices 350A and 350B may use the configuration data to configure themselves to utilize each of the user's first and second computing devices 352A and 352B, as described above in relation to client computing device 250 of FIG. 2.

In the examples described above, controlling access to configuration data based on group membership may simplify for the user the process of controlling access to configuration data for the user's computing devices. In some examples, the user may grant different contact groups the same, different, or overlapping access rights. Furthermore, some groups may inherit all of the access rights of another group, and have additional access rights. For example, the user may specify (e.g., in user's profile 330A) that the members in first contact group 531 have access to the resources of only first resource group 535, while the members of second contact group 533 have access to the resources of both the first and second resource groups 535 and 537. Additionally or alternatively, the user may specify that all members in the users contact list (i.e., the members of all of the user's contact groups) have access to the resources of a particular a resource group (e.g., second resource group 537). Similarly, the user may, for example, specify that all members of the social networking service have access to the resources of a particular resource group, regardless of whether they are included in the users contact list. In such examples, configuration data for a resource in that resource group may be provided to a member not in the user's contact list when the member requests access to the resource. In some examples, in addition to specifying access controls by group, the user may also (e.g., in user's profile 330A) make exceptions to the general access control policies individually for members in the user's contact list 331A and/or individually for resources in the user's resource list 333A.

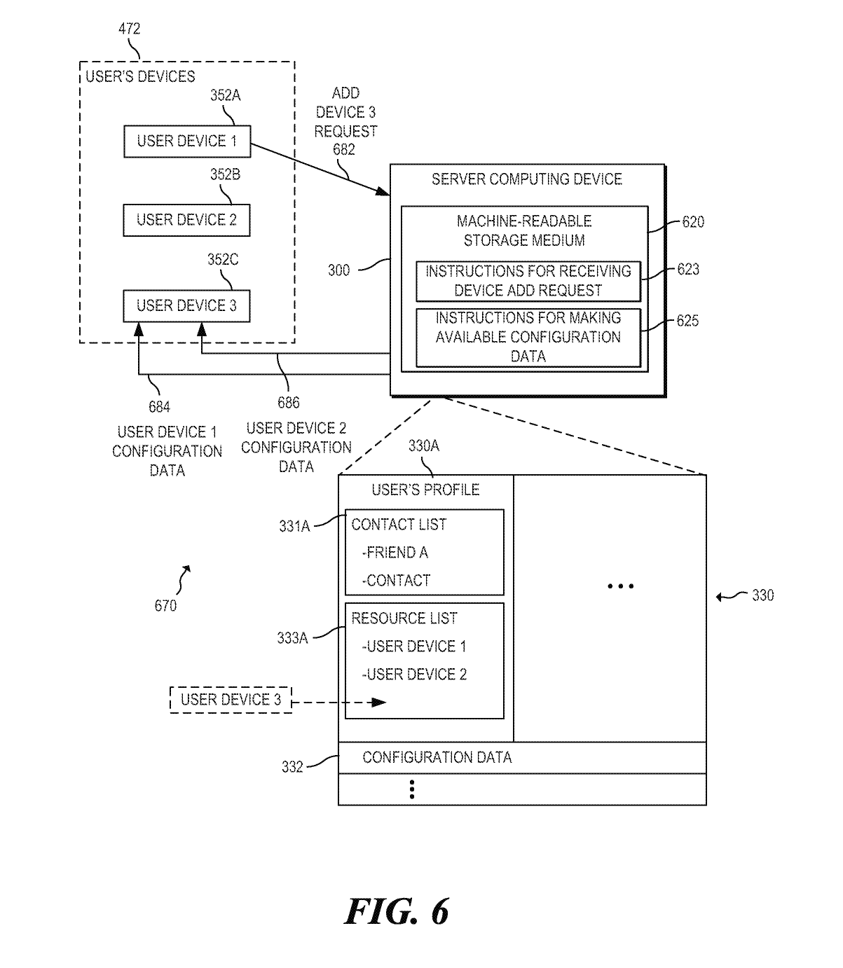

FIG. 6 is a block diagram of an example computer system 670 for configuring a user's computing device 352C to utilize each of a user's other computing devices 352A and 352B. In the example of FIG. 6, computing system 670 comprises the user's resources 472, which include the user's first and second computing devices 352A and 352B. Computing system 670 also comprises a computing device 352C and a server computing device 300 including a machine-readable storage medium 620.

Server computing device 300 is similar to server computing device 300 of FIG. 3, except that machine-readable storage medium 620 includes instructions 623 and 625 in addition to instructions 321, 322 and 324. In the example of FIG. 6, processor 310 may fetch, decode, and execute and/or include a plurality of electronic components for performing some or all of the functionality of instructions 623 and 625. Additionally, in some examples, each of computing devices 352A, 352B, and 352C may be similar to user's computing device 352 described above in relation to FIG. 3.

Server computing device 300 of FIG. 6 may store profiles 330, each including a contact list and a resource list, as described above in relation to FIG. 3. As shown in FIG. 6, contact list 331A of user's profile 330A includes a “Friend A” and a “Contact,” and resource list 333A of user's profile 330A initially includes the user's first and second computing devices 352A and 352B of resource group 472.

Instructions 623 of server computing device 300 may receive a request 682 to add a computing device 352C to the user's resource list. In the example of FIG. 6, request 682 is provided by the user's first computing device 352A. In other examples, request 682 may be provided by any other computing device operated by the user. In response to request 682, instructions 623 may add computing device 352C to user's resource list 333A as the user's third computing device 352C. As shown in FIG. 6, the third computing device 352C may be considered part of the user's resources 472 after the third computing device 352C is added to the user's resource list 333A.

In response to request 682, instructions 625 may make available to the user's third computing device 352C configuration data 332 for each of the other computing devices in the user's resource list 333A. Instructions 625 may make available the configuration data 332 in any manner described above in relation to computing system 100 of FIG. 1. In the example of FIG. 6, instructions 625 may provide configuration data 332 for the user's first computing device 352A to the user's third computing device 352C via a communication 684. Instructions 625 may also provide configuration data 332 for the user's second computing device 352B to the user's third computing device 352C via a communication 686. After receiving the configuration data from server computing device 300, the user's third computing device 352C may use the configuration data to configure itself to utilize each of the user's first and second computing devices 352A and 352B, as described above in relation to client computing device 250 of FIG. 2. In some examples, configuration data 332 may be the same as the configuration data described above in relation to FIG. 3 and/or FIG. 4.

In the examples described above in relation to FIG. 6, one of the user's computing devices may gain access to sufficient information for configuring the device to utilize at least one of the user's other computing devices without the user manually entering the configuration data. In this manner, examples described herein may simplify and streamline the process of sharing resources between a user's own computing devices.

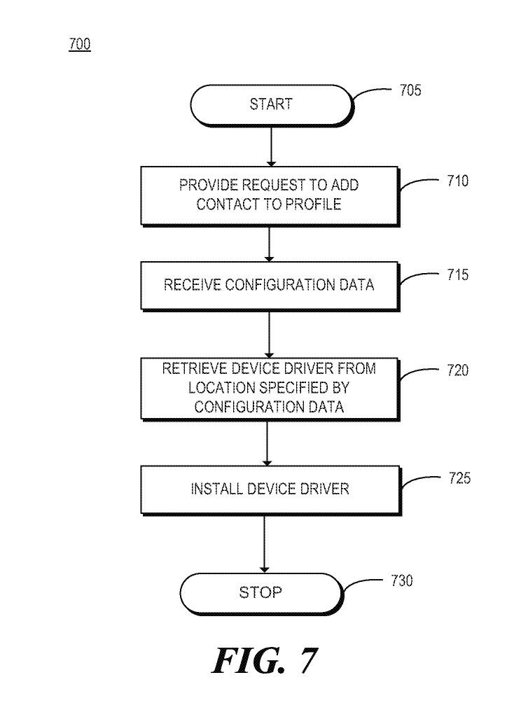

FIG. 7 is a flowchart of an example method 700 for receiving and processing configuration data 332 for a computing device. Although execution of method 700 is described below with reference to client computing device 250 of FIG. 2, other suitable components for execution of method 700 can be utilized (e.g., computing device 350, computing device 352). Additionally, method 700 may be implemented in the form of executable instructions stored on a machine-readable storage medium, such as storage medium 220, in the form of electronic circuitry, or a combination thereof.

Method 700 may start at 705 and proceed to 710, where client computing device 250 may provide a request 230 to add a contact to a user's profile (e.g., to a user's contact list). In some examples, client computing device 200 may provide request 230 to a server computing device, such as computing system 100 of FIG. 1 in examples in which computing system 100 is a server computing device as described above in relation to FIG. 1. Client computing device 250 may be, for example, a computing device associated with the contact.

After providing the request, method 700 may proceed to 715, where client computing device 200 receives configuration data 232. For example, client computing device 200 may receive configuration data 232 for a user's computing device. In some examples, configuration data 232 may include address information for a storage location at which a device driver 234 for the user's computing device is stored.

Method 700 may then proceed to 720, where client computing device 250 may retrieve device driver 234 from the storage location specified by configuration data 232. In some embodiments, the storage location may be local to the server to which client computing device 250 provided the add request at 710. In other examples, the storage location may be remote from the server. In such examples, device driver 234 may be stored at a storage location of a web server.

After retrieving device driver 234, method 700 may proceed to 725, where client computing device 250 may install device driver 234 on client computing device 250. In some examples, device driver 234 may include instructions executable by client computing device 250 that, when executed, enable client computing device 250 to utilize the user's computing device. Method 700 may then proceed to 730, where method 700 may stop.

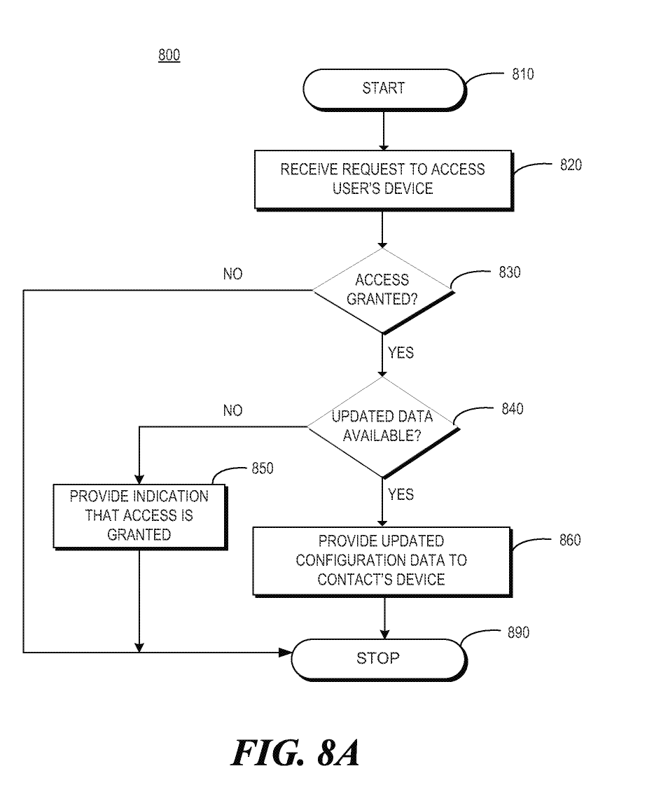

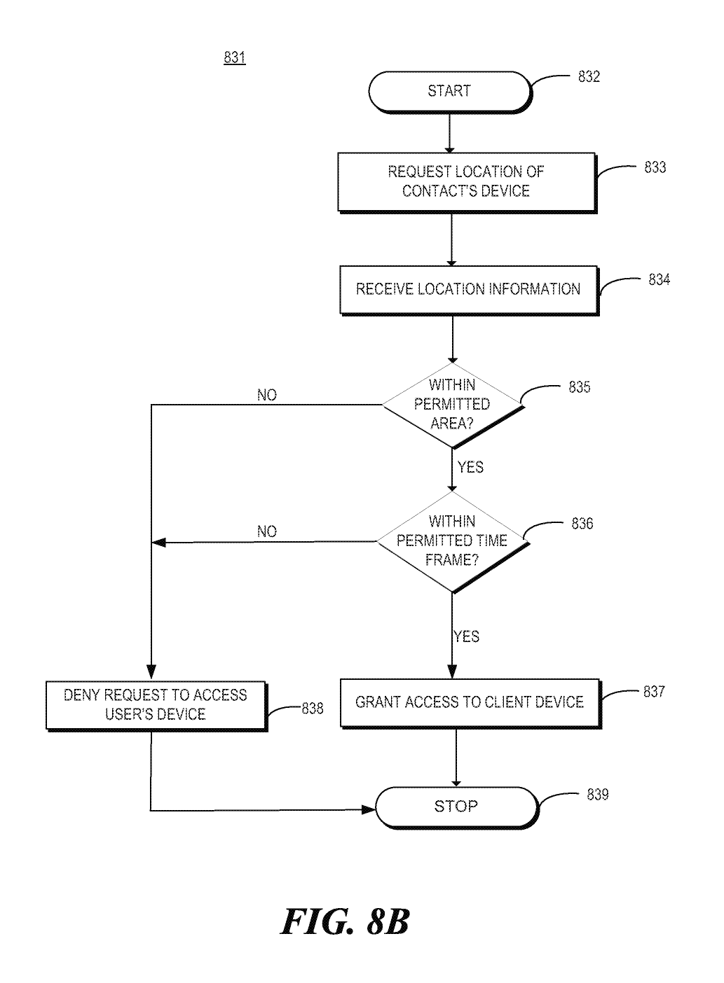

FIG. 8A is a flowchart of an example method 800 for receiving and processing a request to access a client computing device. FIG. 8B is a flowchart of an example method 831 for determining whether to grant a first client computing device access to a second client computing device. Although execution of methods 800 and 831 are described below with reference to server computing device 300 of FIG. 3, other suitable components for execution of these methods can be utilized (e.g., computing system 100). Additionally, methods 800 and 831 may be implemented in the form of executable instructions stored on a machine-readable storage medium, such as storage medium 320, in the form of electronic circuitry, or a combination thereof. Also, although execution of methods 800 and 831 are described below with reference to contact and user computing devices 350 and 352 of FIG. 3, server computing device 300 may interact with other suitable components during execution of method 800 (e.g., client computing device 250).

Method 800 may be used, for example, to determine whether to provide updated configuration data for a user's first computing device to a user's second computing device. Method 800 may start at 810 and proceed to 820, where server computing device 300 may receive a request to access user's computing device 352. The request may be received from contact's computing device 350, for example. After receiving the request, method 800 may proceed to 830, where the server computing device 300 may determine whether to grant contact's computing device 350 access to user's computing device 352. The determination may be made at 830 in accordance with method 831, which is described below with reference to FIG. 8B. If access is not granted at 830, then method 800 may proceed to 890, where method 800 may stop.

If access is granted at 830, then method 800 may proceed to 840, where server computing device 300 may determine whether updated configuration data for user's computing device 352 is available. Server computing device 300 may determine whether updated configuration data is available by determining whether the configuration data for user's computing device 352 has been updated since the server computing device 300 last provided configuration data for user's computing device 352 to client's computing device 350. In some examples, server computing device 300 may maintain electronic records including sufficient information to allow server computing device 300 to make such determinations. Alternatively, server computing device 300 may keep a record of when the configuration data for a particular device was last updated. In such examples, server computing device 300 may make the determination at 840 using an indication received from contact's computing device 350 of when it last received configuration data for the user's computing device 352. This indication may be received, for example, from the contact's computing device 350 along with the access request at 820.

If updated configuration data is not available at 840, then server computing device 300 provides contact's computing device 350 with an indication that access is granted at 850. Method 800 may then proceed to 890, where method 800 may stop. If updated configuration data is available at 840, then method 800 may proceed to 860, where server computing device 300 may provide updated configuration data for user's computing device 352 to contact's computing device 350. Method 800 may then proceed to 890, where method 800 may stop. In this manner, examples described herein may simplify and streamline the process of sharing resources between computing devices by helping to keep configuration data up to date on the computing devices.

As noted above, method 831 may be executed at 830 of method 800 to determine whether to grant contact's computing device 350 access to user's computing device 352. Accordingly, after receiving a request to access user's computing device 352 at 820, method 831 may begin at 832 and proceed to 833, where server computing device 300 requests the current location of the contact's computing device 350. In some examples, contact's computing device 350 may use a global positioning system (GPS) to determine its current location in response to the request. In other embodiments, contact's computing device 350 may determine its position based on the location of an access point through which it is connected to a computer network and/or the Internet. For example, the access point may be any one of a router, a wireless router, a cellular tower, and the like. Then, at 834, server computing device 300 may receive from the contact's computing device 350 information indicating the location of the contact's computing device 350.

After receiving the location information, method 831 may proceed to 835, where server computing device 300 may determine whether contact's computing device 350 is within a permitted area for accessing user's computing device 352. In some examples, server computing device 300 may grant access if contact's computing device 350 is located within a particular radius of user's computing device 352. Server computing device 300 may, for example, store the boundaries of the permitted area, or request the boundaries from user's computing device 352 to make the determination. In some examples, server computing device 300 may store a location of user's computing device 352 or request the current location of user's computing device 352 to make the determination at 835. If server computing device 300 determines that contact's computing device 350 is not within the permitted area, method 831 proceeds to 838, where server computing device 300 denies the request to access user's computing device 352. Method 831 may then proceed to 839, where method 831 may stop.

If contact's computing device 350 is within the permitted area, then method 831 proceeds to 836, where server's computing device 300 determines whether the request was received within a permitted time frame for accessing the device. Server computing device 300 may, for example, store the time frame or request the time frame from the user's computing device.

If server computing device 300 determines that the request was not made within the permitted time frame, then method 831 proceeds to 838, where server computing device 300 denies the request to access user's computing device 352. Method 831 may then proceed to 839, where method 831 may stop. If the request was made within the permitted time frame, then method 831 proceeds to 837, where server's computing device 300 grants contact's computing device 350 access to user's computing device 352. Method 831 may then proceed to 839, where method 831 may stop. In alternative examples of method 831, more or fewer access control determinations may be made prior to providing access to a user's computing device. By providing the types of access controls described above, the user may be able to reduce the overuse and/or abuse of the user's computing device by their contacts.

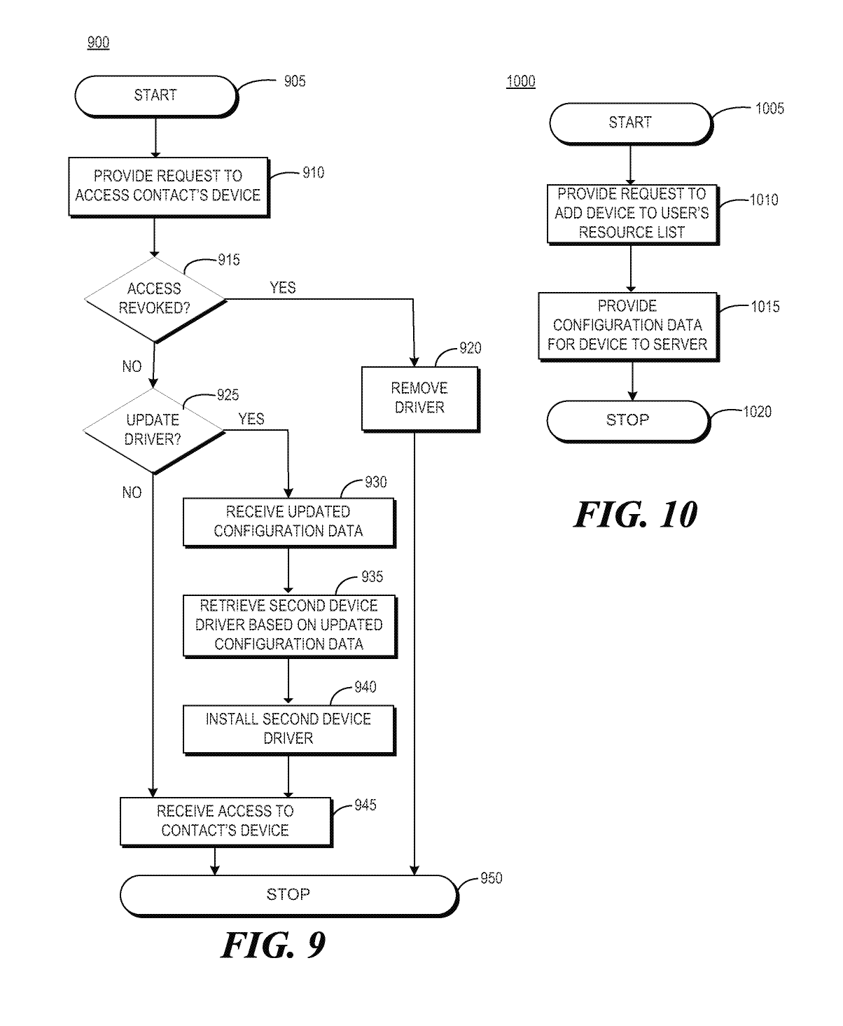

FIG. 9 is a flowchart of an example method 900 for requesting to access a client computing device. Although execution of method 900 is described below with reference to contact's computing device 350 of FIG. 3, other suitable components for execution of method 900 can be utilized (e.g., client computing device 250). Additionally, method 900 may be implemented in the form of executable instructions stored on a machine-readable storage medium, such as storage medium 220, in the form of electronic circuitry, or a combination thereof. Also, although execution of method 900 is described below with reference to server and user computing devices 300 and 352 of FIG. 3, contact's computing device 350 may interact with other suitable components during execution of method 900 (e.g., client computing device 250). For example, method 900 may be implemented by the contact's first computing device to request access to the contact's second computing device.

Method 900 may start at 905 and proceed to 910, where contact's computing device 350 may provide server computing device 300 with a request to access user's computing device 352. After providing the request, contact's computing device 350 may determine at 915 whether it has received any indication that its access to user's computing device 352 has been revoked. If contact's computing device 350 determines that it has received such an indication (e.g., from server computing device 300) then method 900 proceeds to 920. At 920, contact's computing device 350 may remove (e.g., delete, uninstall, etc.) any device driver or configuration data for user's computing device 352 stored or installed on contact's computing device. After removal, method 900 proceeds to 950, where method 900 may stop.

If contact's computing device 350 determines at 915 that it has not received an indication that its access to user's computing device 352 has been revoked, then method 900 proceeds to 925. At 925, contact's computing device 350 may determine whether it has received any indication that an updated device driver or updated configuration information for the user's computing device is available. If contact's computing device receives an indication that no updated data is available, then method 900 proceeds to 945, where contact's computing device 350 receives an indication that it is granted access to utilize user's computing device 352. Method 900 may then proceed to 950, where method 900 may stop.

If contact's computing device receives an indication that updated data is available, then method 900 proceeds to 930, where contact's computing device 350 receives updated configuration data for user's computing device 352. After receiving the updated information, contact's computing device may retrieve a second device driver at 935, in a manner similar to that described above in relation to FIG. 7. After retrieving the second device driver, contact's computing device 350 may install the second device driver at 940. In the example of FIG. 9, method 900 may then proceed to 945, where contact's computing device 350 receives an indication that it is granted access to utilize user's computing device 352. Method 900 may then proceed to 950, where method 900 may stop.

In this manner, examples described herein may simplify and streamline the process of sharing resources between computing devices by helping to keep configuration data up to date on the computing devices granted access to other computing devices. Additionally, examples described above in relation to FIG. 9 may help assure that a primary computing device is not able to utilize a second computing device after the primary computing device's access has been revoked.

FIG. 10 is a flowchart of an example method 1000 for adding a computing device to a user's resource list. Although execution of method 1000 is described below with reference to user's computing device 352 of FIG. 3, other suitable components for execution of method 1000 can be utilized (e.g., client computing device 250). Additionally, method 1000 may be implemented in the form of executable instructions stored on a machine-readable storage medium, such as storage medium 390, in the form of electronic circuitry, or a combination thereof. Also, although execution of method 1000 is described below with reference to server computing device 300 of FIG. 3, user's computing device 352 may interact with other suitable components during execution of method 1000 (e.g., computing system 100).

Method 1000 may start at 1005 and proceed to 1010, where user's computing device 352 may provide server computing device 300 with a request to add user's computing device 352 to the user's resource list 333A. After providing the request, method 1000 may proceed to 1015, where user's computing device 352 may provide server computing device 300 with configuration data for user's computing device 352. The configuration data may be similar to configuration data 232 described above. In some embodiments, after receiving the configuration data for user's computing device 352, server computing device 300 may provide the configuration data to other client computing devices so that the client computing devices can be configured to utilize user's computing device 352. After providing the configuration data to server computing device 300, method 1000 may proceed to 1020, where method 1000 may stop.

In this manner, examples described herein may simplify and streamline the process of sharing resources between computing devices by enabling a computing device to provide configuration data for the computing device to a centralized server where it may be accessed by other computing devices.

What is claimed is:

1. A computing system comprising:
a processor; and
a machine-readable storage medium encoded with instructions executable by the processor, the machine-readable storage medium comprising:
instructions for receiving a request to add a contact to a user's profile; and
instructions for making available, to a first computing device associated with a contact's profile, configuration data for a second computing device associated with the user's profile in response to the request, wherein the configuration data is useable by the first computing device to obtain instructions executable by the first computing device that, when executed, enable the first computing device to utilize the second computing device.

2. The system of claim 1, wherein the configuration data comprises address information associated with a location at which the instructions are stored.

3. The system of claim 1, wherein the instructions executable by the first computing device are at least a portion of a device driver.

4. The system of claim 1, wherein the instructions executable by the first computing device, when executed, enable the first computing device to utilize the second computing device independent of any client program, of the second computing device, useable to communicate with the processor.

5. The system of claim 1, wherein the machine-readable storage medium further comprises:
instructions for receiving, from the first computing device, a request to utilize the second computing device;
instructions for determining whether an access control policy is satisfied; and
instructions for granting access to the second computing device if the access control policy is satisfied.

6. The system of claim 5, wherein the instructions for determining whether the access control policy is satisfied comprise:
instructions for requesting location information from the first computing device; and
instructions for determining that the access control policy is satisfied if the location information corresponds to a location within a permitted area for the second computing device.

7. A non-transitory machine-readable storage medium encoded with instructions executable by a processor that, when executed, cause the processor to:
store a user's profile;
receive a request to alter a user's profile; and
make available, to a first computing device, first configuration data stored in a database for a second computing device identified in the user's profile in response to the request to alter the user's profile, wherein the first configuration data is useable by the first computing device to obtain a first device driver usable to enable the first computing device to utilize the second computing device.

8. The machine-readable storage medium of claim 7, wherein the instructions, when executed, cause the processor to:
receive a request to add a third computing device to the user's profile as the request to alter the user's profile; and
make available, to the third computing device, second configuration data stored in the database for the second computing device in response to the request to add the third computing device, wherein the second configuration data is useable by the third computing device to obtain a second device driver usable to configure the third computing device to utilize the second computing device.

9. The machine-readable storage medium of claim 7, wherein the instructions, when executed, cause the processor to:
store a contact's profile, wherein the user's profile and the contact's profile each comprise a contact list and a resource list; and
receive a request to add the contact to the user's contact list as the request to alter the user's profile, wherein the first computing device is identified in the contact's resource list and the second computing device is identified in the user's resource list.

10. The machine-readable storage medium of claim 9, wherein the instructions, when executed, cause the processor to:
make available, to the first computing device, second configuration data stored in the database for a third computing device identified in the user's resource list in response to the request to add the contact, wherein the second configuration data is useable by the first computing device to obtain a second device driver usable to configure the first computing device to utilize the third computing device; and
make available, to a fourth computing device identified in the contact's resource list, third configuration data stored in the database for the third computing device in response to the request to add the contact, wherein the third configuration data is useable by the fourth computing device to obtain a third device driver usable to configure the fourth computing device to utilize the third computing device.

11. The machine-readable storage medium of claim 9, wherein the user's contact list comprises first and second contact groups, the user's resource list comprises first and second resource groups, the first resource group identifies a plurality of computing devices including the second computing device, the request to add the contact is a request to add the contact to the user's first contact group, and the instructions, when executed, cause the processor to:
make available, to the first computing device, second configuration data stored in the database in response to the request to add the contact, wherein the second configuration data includes the first configuration data and is useable by the first computing device to obtain a plurality of device drivers, including the first device driver, usable to configure the first computing device to utilize each of the plurality of computing devices identified in the first resource group.

12. A method comprising:
providing, to a server computing device with a first client computing device, a request to add a contact to a user's profile, wherein the first client computing device is associated with the user's profile;
receiving, from the server computing device with the first client computing device, configuration data for a second client computing device associated with a profile of the contact;
retrieving, with the first client computing device, a first device driver for the second client computing device from a location specified by the configuration data; and
installing the first device driver on the first computing device to enable the first client computing device to utilize the second client computing device.

13. The method of claim 12, further comprising:
providing, to the server computing device with the first client computing device, a request to access the second client computing device;
receive, with the first client computing device, updated configuration data for the second client computing device;
retrieving, with the first client computing device, a second device driver for the second client computing device from a location specified by the updated configuration data; and
replacing at least a portion of the first device driver with at least a portion of the second device driver.

14. The method of claim 12, further comprising:
providing, to the server computing device with the first client computing device, a request to access the second client computing device;
receive, with the first client computing device, instructions to remove the first device driver from the first client computing device.

15. The method of claim 12, further comprising:
providing, to the server computing device with the first client computing device, second configuration data useable to configure the second client computing device to utilize the first client computing device.
